(19) United States
(12) Patent Application Publication
(10) Pub. No.: US 2005/0040323 A1
(43) Pub. Date: Feb. 24, 2005

(54) Cylindrical encoder

(76) Inventors: Chee-Keong Chong, Penang (MY); Boon Kheng Lee, (US); Kee Siang Goh, Penang (MY)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/646,654

(22) Filed: Aug. 21, 2003

(51) Int. Cl. G01D 5/34

(52) U.S. Cl. 250/231.13; 250/231.14

(57) ABSTRACT

A cylindrical encoder has a cylinder with a coding surface that is disposed about a rotational axis. The coding surface has code lines that spiral along the cylinder about the rotational axis. Resolution depends on the pitch, or spacing, of the code lines, and on the angle at which the code lines are oriented to the rotational axis. An imaging system positioned for optical coupling to the coding surface senses a succession of moving code lines as the cylinder rotates about the rotational axis.

### BACKGROUND OF THE INVENTION

Optical encoders are typically included within electromechanical control systems to detect position, velocity, acceleration or other motion parameters. Within an optical encoder is an optical emitter/detector pair and a code wheel that operate in a transmissive, reflective, or imaging configuration.

In the transmissive configuration (shown in FIG. 1A), the optical emitter and detector are positioned on opposite sides of the code wheel with light from the optical emitter directed toward the optical detector. When the code wheel rotates through the light path between the optical emitter and the optical detector, optically transmissive, or light, bands of the code wheel that intercept the light path enable the light from the optical emitter to be provided to the optical detector. Non-transmissive, or dark, bands of the code wheel that intercept the light path prevent the light provided by the optical emitter from being received by the optical detector. The resulting interruptions of the light are then used to establish the motion parameters of the code wheel, based on the number of interruptions in the light received by the optical detector and the temporal characteristics of the interruptions in the received light.

In the reflective configuration (shown in FIG. 1B), the optical emitter and optical detector are positioned on the same side of the code wheel, with light from the optical emitter being directed toward the code wheel. As the code wheel rotates through the light path, optically reflective bands of the code wheel that intercept the light path redirect the light provided by the optical emitter toward the optical detector. Optically non-reflective bands of the code wheel that intercept the light path do not redirect the light to the optical detector. This results in interruptions in the light being received by the optical detector that can be used to provide information about the motion parameters of the code wheel.

The imaging configuration of the optical encoder (shown in FIG. 1C) is different from the reflective configuration of FIG. 1B, in that imaging optics are included in the light path so that the bands of the code wheel with distinguishing optical attributes are imaged onto the optical detector and used to provide motion parameters of the code wheel.

An optical code wheel (shown in FIG. 2) suitable for inclusion in optical encoders has a resolution, typically measured in the number of counts per revolution, that is determined by the number of alternating optically transmissive and non-transmissive bands per inch (or other units of measure) at the operating radius of the code wheel. Once the number of bands per unit measure is designated, the number of counts per revolution is adjustable according to the operating radius or by interpolation. Adjusting the operating radius has the disadvantage of causing corresponding variations in the physical size of the optical encoder within which the code wheel is included. Interpolation adds to the complexity of the optical encoder in which the code wheel is included and typically increases noise susceptibility, which may result in errors in the sensed position, velocity or acceleration of the code wheel sensed by the optical emitter/detector pair.

### SUMMARY OF THE INVENTION

According to the embodiments of the present invention, a cylindrical encoder has a cylinder with a coding surface that is disposed about a rotational axis. The coding surface has code lines that spiral along the cylinder about the rotational axis. Resolution is dependent not only on the pitch, or spacing, of the code lines, but on the angle at which the code lines are oriented to the rotational axis. An imaging system positioned for optical coupling to the coding surface senses a succession of moving code lines as the cylinder rotates about the rotational axis.

### BRIEF DESCRIPTION OF THE DRAWINGS

FIG. 1A shows a side view of an optical encoder in a transmissive configuration.

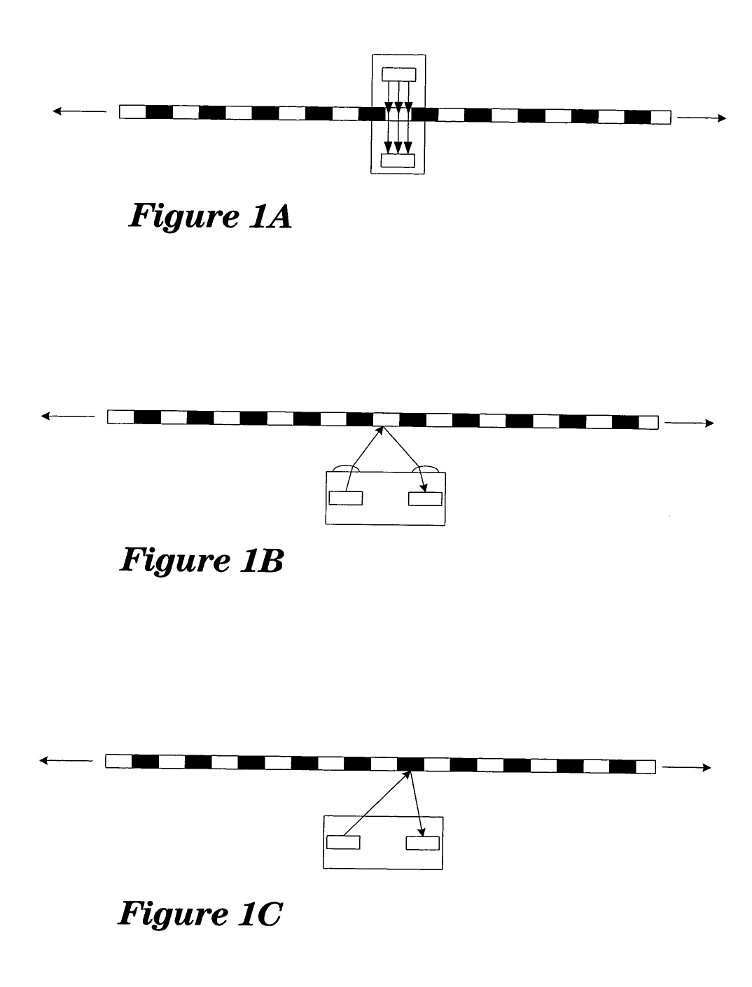

FIG. 1B shows a side view of an optical encoder in a reflective configuration.

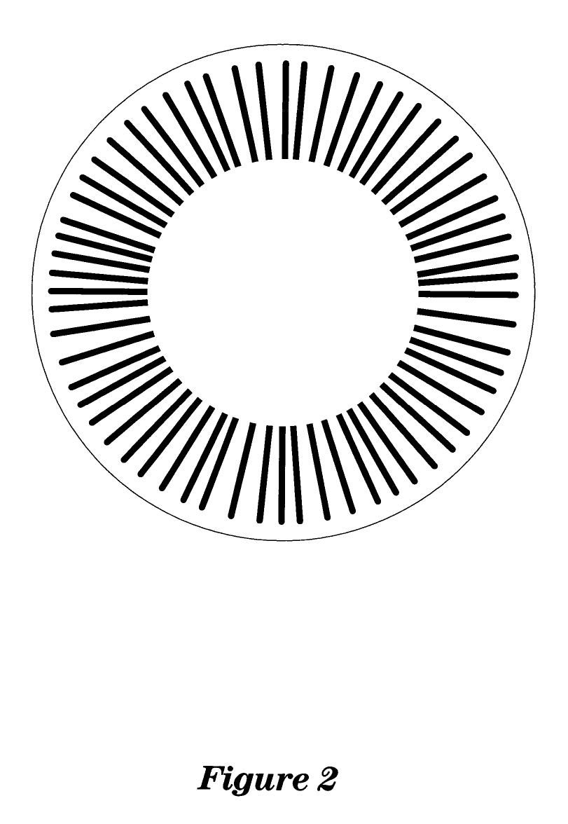

FIG. 1C shows a side view of an optical encoder in an imaging configuration.

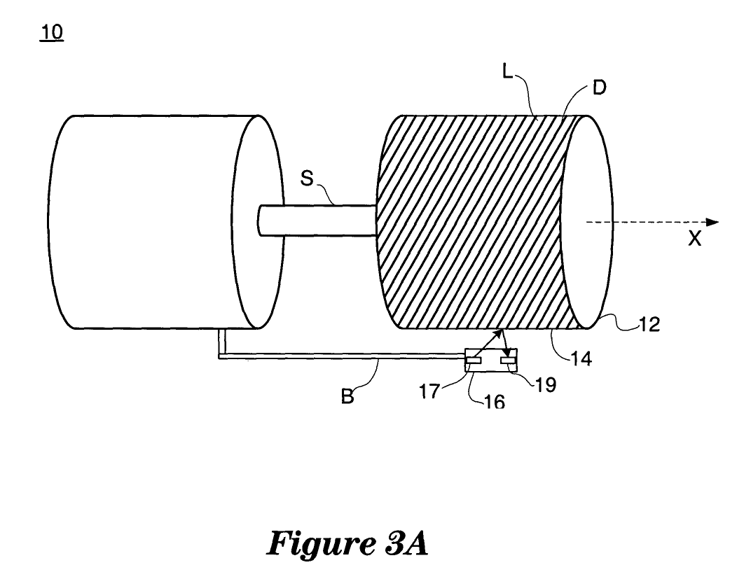

FIG. 2 shows a top view of a code wheel for the optical encoders of FIGS. 1A-1C.

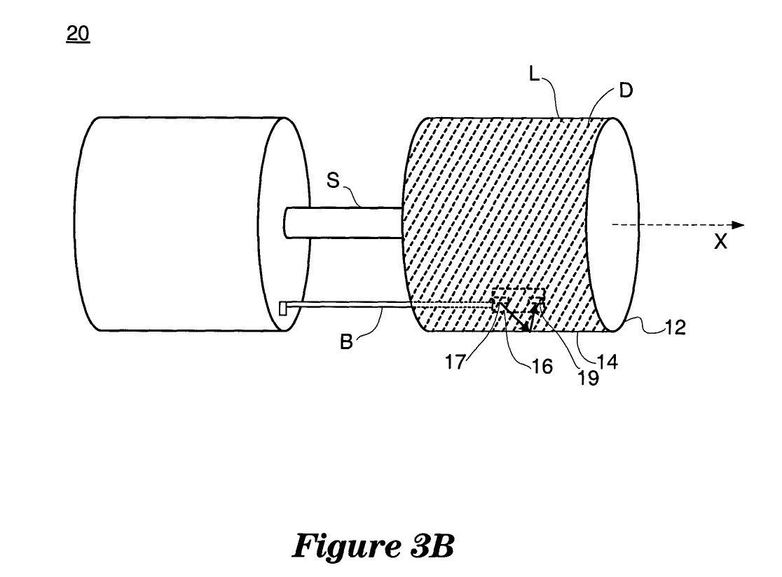

FIGS. 3A-3C show cylindrical encoders according to alternative embodiments of the present invention.

FIG. 4 shows a detailed side-view of cylinder having a coding surface, suitable for inclusion in the cylindrical encoder of FIGS. 3A-3C.

### DETAILED DESCRIPTION

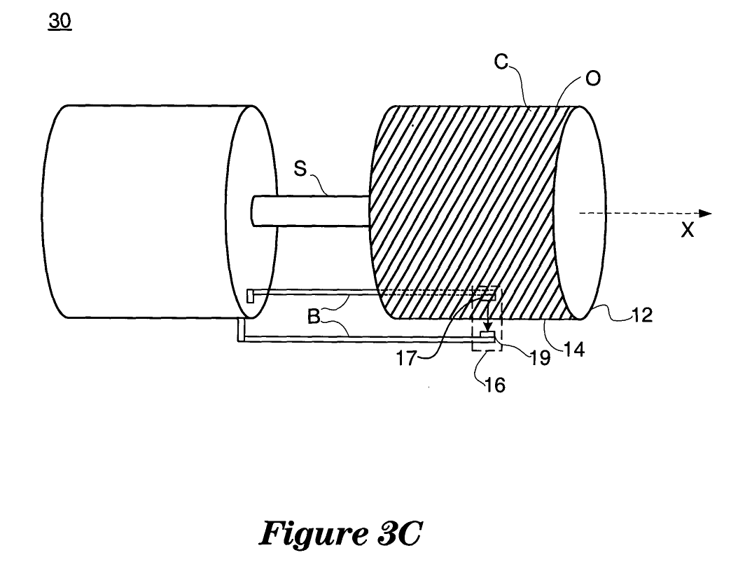

According to the embodiments of the present invention, cylindrical encoders 10, 20, 30 (shown in FIGS. 3A-3C) have a cylinder 12 with a coding surface 14 that is disposed about a rotational axis X. The coding surface 14 has code lines L, D, that spiral along the cylinder 12 about the rotational axis X. An imaging system 16 is positioned for optical coupling to the coding surface 14 and senses movement of the code lines L, D relative to the imaging system 16 as the cylinder 12 rotates about the rotational axis X. Optionally included detector circuits (not shown) coupled to the imaging system 16 generate logic states that correspond to the alternating code lines L, D detected by the imaging system 16. In the examples shown, the optical encoders 10, 20, 30 are coupled to a motor shaft S. However, it is appreciated that the cylinder 12 and other elements of the cylindrical encoders are alternatively coupled to a variety of systems wherein the cylinder 12 is suitably mounted for rotation about the rotational axis X.

The imaging system 16 includes an optical emitter 17 and an optical detector 19. Typically, the optical emitter 17 includes one or more LEDs, laser diodes or other light generators, and associated lenses, collimators or other optical elements suitable for directing light to the coding surface 14. The optical detector 19 typically includes one or more photodiodes or other semiconducters or devices that convert received light into electrical signals, and associated lenses, collimators or other optical elements suitable for directing light to the optical detector 19.

In a reflective configuration of the cylindrical encoder 10 constructed according to a first embodiment of the present invention, the coding surface 14 is on the outer surface of the cylinder 12 and the imaging system 16 is external to the cylinder 12, as shown in FIG. 3A. The imaging system 16 is mounted on one or more brackets B as shown, on a housing, or the imaging system 16 is otherwise secured in position external to the cylinder 12. The code lines L, D are an alternating series of optically reflective, or light, bands L and non-reflective, or dark, bands D having relative differences in reflectivity sufficiently large to be distinguishable by the optical detector 19. The imaging system 16 is positioned so that light from the optical emitter 17 is directed toward the coding surface 14. As the cylinder 12 rotates about the rotational axis X, the optically reflective bands L of the coding surface 14 that intercept the light path redirect light from the optical emitter 17 to the optical detector 19. The optically non-reflective bands D of the coding surface 14 that intercept the light path do not redirect the light to the optical detector 19. Thus, there are interruptions in the light received by the optical detector 19 that occur as a result of the rotation of the cylinder 12 about the rotational axis X. The number of interruptions and the temporal characteristics of the interruptions are converted into corresponding electrical signals by the optical detector 19. When coupled to the cylindrical encoder 10, the optionally included detector circuit processes the electrical signals to establish the position, velocity, acceleration, or other motion parameters resulting from rotation of the cylinder 12.

With the cylindrical encoder 10 in an imaging configuration, the code lines L, D are an alternating series of bands of different luminosity or other optically distinct characteristics so that the code lines L, D are imaged onto the optical detector 19 based on the optical characteristics of the bands. The imaging configuration of the cylindrical encoder 10 is different from the reflective configuration of FIG. 3A in that imaging optics are included in the light path so that distinguishing optical characteristics of the code lines L, D are imaged onto the optical detector 19. The optical detector 19 then converts the imaged code lines L, D to corresponding electrical signals that can be processed to detect position, velocity, acceleration, and/or other motion parameters resulting from rotation of the cylinder 12.

In alternative embodiments of the present invention shown in FIG. 3B, the coding surface 14 of the cylinder 12 of the cylindrical encoder 20 is on an inner surface of the cylinder 12 and the imaging system 16 is positioned internal to the cylinder 12. This results in a physically-compact arrangement for the cylindrical encoder 20 that typically operates in the reflective configuration or the imaging configuration.

In another alternative embodiment of the present invention shown in FIG. 3C, the cylindrical encoder 30 operates in a transmissive configuration. Here, the cylinder 12 has a series of code lines including alternating transmissive or clear, bands C, and relatively non-transmissive, or opaque, bands O having relative differences in optical transmission sufficiently large to be distinguishable by the optical detector 19. In this example, the optical emitter 17 and the optical detector 19 of the imaging system 16 are on opposite surfaces of the cylinder 12. Particularly, the optical emitter 17 is internal to the cylinder 12 with the optical detector 19 external to the cylinder 12 (as shown), or the optical emitter 17 is external to the cylinder 12 with the optical detector 19 internal to the cylinder 12. As the cylinder 12 rotates through the light path between the optical emitter 17 and the optical detector 19, optically non-transmissive bands O of the cylinder 12 that intercept the light path interrupt the light to the optical detector, whereas optically transmissive bands C of the cylinder 12 that intercept the light path enable the light from the optical emitter 17 to be received by the optical detector 19. The resulting interruption of the light received by the optical detector 19 enables position, velocity, acceleration, or other motion parameters resulting from rotation of the cylinder 12 to be established, typically based on the number of interruptions in the light received by the optical detector 19 and the temporal characteristics of the interruptions.

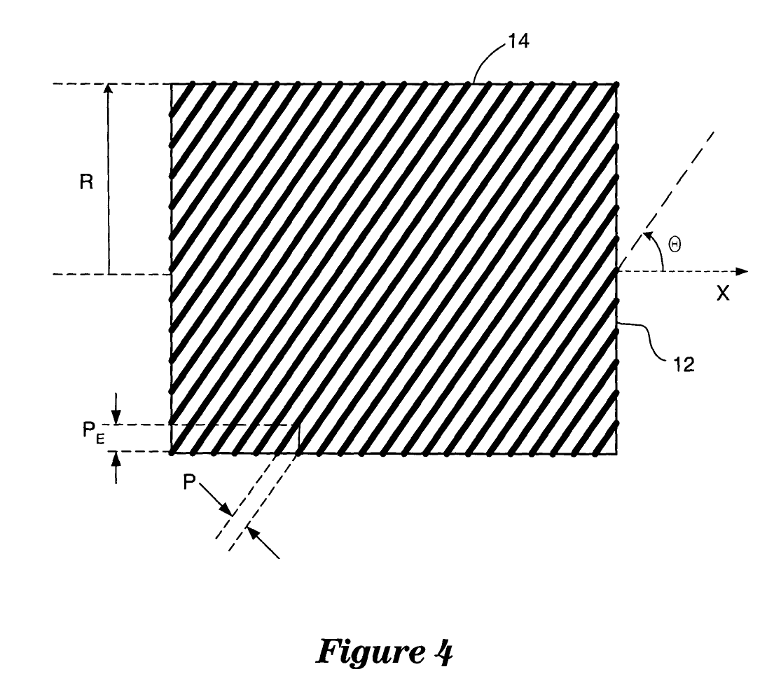

FIG. 4 shows a detailed side-view of the cylinder 12 suitable for inclusion in the cylindrical encoders 10, 20, 30 of FIGS. 3A-3C. The coding surface 14 of the cylinder 12 has a radius R and has code lines 14 having a separation distance between bands, or pitch, P. The spiral arrangement of the code lines resulting from the angular orientation of the code lines 14 provides an effective pitch P_{E}=P/COS(θ), where θ is the angle at which the code lines 14 are oriented to the rotational axis X. For a given pitch P, the resolution, or number of bands per revolution of the cylinder 12 about the rotational axis X, is 2πRcos(θ)/P. Thus, the resolution of the cylindrical encoders 10, 20, 30 within which the cylinder 12 is included, can be adjusted according to the angle θ at which the code lines 14 are oriented to the rotational axis X.

While the embodiments of the present invention have been illustrated in detail, it should be apparent that modifications and adaptations to these embodiments may occur to one skilled in the art without departing from the scope of the present invention as set forth in the following claims.

1. A cylindrical encoder, comprising:
a cylinder having a coding surface disposed about a rotational axis, the coding surface having a series of code lines that spiral about the rotational axis; and
an imaging system sensing movement of the series of code lines when the cylinder rotates about the rotational axis.

2. The cylindrical encoder of claim 1 wherein the coding surface is on the outer surface of the cylinder and the imaging system is external to the cylinder.

3. The cylindrical encoder of claim 1 wherein the coding surface is on the inner surface of the cylinder and the imaging system is internal to the cylinder.

4. The cylindrical encoder of claim 1 wherein the series of code lines includes alternating optically transmissive bands and optically non-transmissive bands, and wherein the imaging system includes an optical emitter internal to the cylinder and an optical detector external to the cylinder.

5. The cylindrical encoder of claim 1 wherein the series of code lines includes alternating optically transmissive bands and optically non-transmissive bands, and wherein the imaging system includes an optical detector internal to the cylinder and an optical emitter external to the cylinder.

6. The cylindrical encoder of claim 1 wherein the code lines have a predesignated pitch and are at a predesignated angle relative to the rotational axis providing an effective pitch for the code lines that is greater than the predesignated pitch.

7. The cylindrical encoder of claim 6 wherein the cylindrical encoder has a resolution that is proportional to the radius of the cylinder and inversely proportional to the effective pitch.

8. The cylindrical encoder of claim 7 wherein the coding surface is on the outer surface of the cylinder and the imaging system is external to the cylinder.

9. The cylindrical encoder of claim 7 wherein the coding surface is on the inner surface of the cylinder and the imaging system is internal to the cylinder.

10. The cylindrical encoder of claim 7 wherein the series of code lines includes alternating optically transmissive bands and optically non-transmissive bands, and wherein the imaging system includes an optical emitter internal to the cylinder and an optical detector external to the cylinder.

11. The cylindrical encoder of claim 7 wherein the series of code lines includes alternating optically transmissive bands and optically non-transmissive bands, and wherein the imaging system includes an optical detector internal to the cylinder and an optical emitter external to the cylinder.
